(19) United States
(12) Patent Application Publication
(10) Pub. No.: US 2009/0303848 A1
(43) Pub. Date: Dec. 10, 2009

(54) OPTICAL DISCS WITH IDENTIFICATION CODE

(75) Inventor: Petrus Henricus Cornelius Bentvelsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/296,678

(22) PCT Filed: Apr. 2, 2007
(86) PCT No.: PCT/IB2007/051167

§ 371 Date: Oct. 10, 2008

(30) Foreign Application Priority Data
Apr. 11, 2006 (EP) 06112451.7

(51) Int. Cl. G11B 19/02

(52) U.S. Cl. 369/47.1; G9B/19.001

(57) ABSTRACT

An individual code can be recorded on optical discs with post-recording techniques like for example laser-ablation. This normally requires the presence of an ad-hoc decoder in a corresponding playback apparatus. According to the invention this individual code is recorded by using an encoding scheme which is different from the encoding scheme proper of the user data but equal to the encoding scheme proper of control data already foreseen in the disc, like for example PIC in the case of a BD. In this way an ad-hoc decoder is no longer required and a suitable playback apparatus capable of acquiring individual code can be obtained with minimal modifications of an existing playback apparatus.

The present invention relates to a method of recording data on a recording medium, to a corresponding apparatus, to the recording medium, and to corresponding method and apparatus to read data from the recording medium.

In optical disc data formats such as CD, DVD and BD (compact disc, digital versatile disc, and Blu-ray disc), information is stored in the data layer of the disc in the form of pits (or recorded marks) and lands. The pits and lands are mastered or recorded so as to form a spiral track in the data layer. An optical head in a reading device reads out the pit/land pattern. If the optical head is not positioned exactly in the center of the track formed by the pits and lands, the diffraction of the light may be different. This difference is detected on the detector and may result in an error signal. Typically, the optical head is controlled so as to adjust its radial position on the track such that any error signal is minimized, in other words it has a tracking servo loop. The response on a detected error in radial position has a finite bandwidth, due to the mechanical constraints of the optical head and the electrical limitations of its associated actuator motor.

Similarly, on recordable and rewritable discs in the CD, DVD and BD systems, an unwritten disc contains a spiral groove. The diffraction of light caused by the presence of the groove is similar to that of the presence of pits and lands on a prepressed disc, and also gives an error signal that can be used to follow the track even if no recorded marks are present. In the following the expression track is used to refer either a succession of pits and lands or a groove, in absence of pits and lands. This groove may have a (periodical) radial displacement from its virtual spiral track position (e.g. a sinusoidal deviation; generally this periodical deviation is called the groove ‘wobble’). If, given a certain scanning velocity, the spatial frequency of this deviation is chosen such that it is outside the bandwidth of the optical head's radial movement, the optical head is not able to follow the wobble, but remains positioned at the average groove position, which is the virtual track center. The radial error signal will be proportional to the difference between the virtual track center and the actual groove position. It is possible to store information in this radial displacement, e.g. by varying the frequency or the phase of the wobble, or according to a more complex scheme such as Minimum Shift Keying and Sawtooth Wobble in the BD system. The information stored in the groove wobble is retrieved by the drive through processing the radial error signal. If the optical head writes recording marks, they will be placed on the virtual track center (so the recorded marks may have an offset to the actual groove location).

Pre-pressed disc formats generally do not foresee a groove, however they may still foresee the storage of information in the radial displacement of the pit pattern from its virtual track center, the so-called ‘pit-wobble’. During mastering of the disc, the laser beam is deflected in radial direction using e.g. an acousto-optical deflector. This deflection can be done at a sufficiently high frequency. The information stored in the pit-wobble can be retrieved in the same way as the information from the groove-wobble, i.e. looking at the error signal in the tracking servo loop.

The groove wobble is generally used to store information about its position on the disc (e.g. sector number), which is used by the drive (in case a specific sector, ECC-block or cluster is not yet written) to position the optical head to the right location (e.g. to start writing at that location). Generally, the position information stored in the groove wobble is copied to the information contained in the recorded marks. During read-out of the recorded areas, the position information from the written marks is used, such that the information from the groove wobble is no longer necessary. The groove wobble can also be used to store other information about the disc (such as disc manufacturer information, or required write strategy). Generally, this information is also copied to the information contained in the recorded marks, either during an initialization process or a finalization process.

The pit-wobble, as it is used in a pre-pressed disc, generally does not contain positioning information, but may be used e.g. to contain access rights information or copy protection information, for example. Alternatively, merely existence of pit-wobble may be used as a proof that the disc is an original (i.e. non-copied) disc. Since a pit-wobble cannot be recorded by an optical disc drive because of the physical constraints of the optical pickup head, the existence of a specific wobble in a disc is a proof that the disc is prepressed (a drive may not detect the difference between prepressed and recorded marks, because both will give the same read-out signal). Moreover, a recordable/rewritable disc already has a wobble that may have a different frequency or may contain different data or is encoded in a different data format.

According to the BD standard, in a dedicated area at the inner diameter of the disc a groove is present wobble exists containing the so-called PIC data (Permanent Information & Control data). This groove carries data modulated in a radial displacement from the center of the track, however the modulation has features different from the traditional wobble modulation of the groove in recordable discs, in particular for what concerns the density of the data therein encoded.

For some applications, for example in the field of authentication and access control, it is convenient that a disc is provided with an individual code, such as for example a Unique Disc ID or a progressive number. This individual code cannot be pre-recorded on the disc, given the fact that it cannot be the same for all discs, but instead it needs to be individually added after the disc has been produced. Moreover it is convenient that this individual code is added with a technique not available or easily reproducible with standard user equipment.

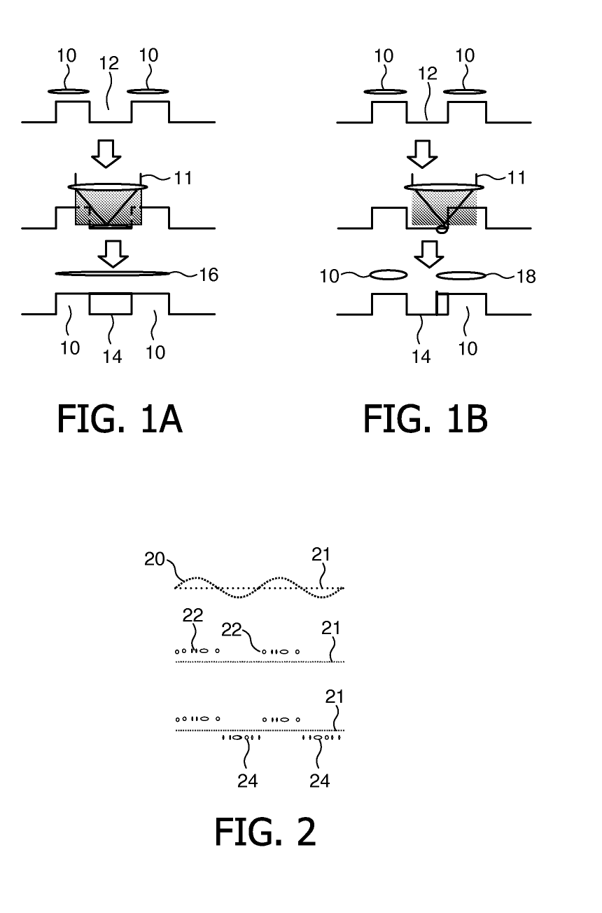

A system has been proposed in which a Unique Disc ID is recorded onto a read-only disc after disc production. In this system, lands between the stamped pits are converted (such that they give a pit-like reflection) using laser ablation. The thin film reflective layer (that usually consists of aluminium for conventional discs) has a special composition to allow ablation of the layer. After ablation, the local reflectance will be low and comparable to a stamped pit. So with this technique it is possible to adapt the modulation stream, and hence the data-content. FIGS. 1A and 1B of the accompanying drawings illustrate this technique. The data marks (pits) following production are indicated by numeral 10. An exemplary land is shown by numeral 12. In the technique of FIGS. 1A and 1B, a laser 11 is used to change the land 12 such that a single pit 16 is effectively produced (FIG. 1A) or an enraged pit 18 is produced (FIG. 1B). Such adjustment of the pit/land pattern enables information to be encoded uniquely onto a disc. However, the method shown in FIGS. 1A and 1B has the disadvantage that a special data decoder has to be built to decode the unique identifier channel bit data. Typically, other methods of recording a unique identifier also suffer from the disadvantage that hardware modification is required to be able to detect the unique identifier channel bits.

It is an object of the present invention to provide a technique that can be applied to a BD and overcomes the disadvantages of the prior art.

This object is fulfilled according to a first aspect of the present invention by a method of recording data on a recording medium as claimed in claim 1.

In fact according to the invention the known post recording technique is applied for recording marks on the disc to form a path that has a transversal displacement from the center of the track. The information that is so recorded is modulated into the transversal displacement using the same rules used for the primary control data, which for example in the case of a BD is the PIC. In this way, no special decoder is needed for reading back this secondary control information: in an existing playback apparatus the suitable decoding unit is already present and it is the one used to acquire the primary control data, therefore an existing playback apparatus can with minor adaptations be instructed to use the decoding unit used to acquire the primary control data to acquire the secondary control information as well.

The reserved area of the data track may be substantially free of any variations in radial position or may have a wobble modulation, though different from the wobble modulation present in part or in all of the rest of the user data portion of the data track. The primary control data portion of the data track may have physical characteristics different to those of the modulated portion of the data track.

Clearly the obtained path will vary in radial position with respect to the center of the control data portion of the data track at a frequency above a predetermined frequency, the predetermined frequency being such as to cause an optical head to detect a modulated radial tracking signal when data marks located along the control data portion of the data track are read.

Various types of modulation can be used for the secondary control information and the primary control data, like for example phase modulation, frequency modulation or base-band modulation.

The data marks may be written to a single side of the data track. Alternatively, the data marks may be written to the disc to the first and second sides of the data track. The data marks may be written to the disc in a single recording pass, or in at least two recording passes. The writing in two or more recording passes has the advantage that the recording can take place at higher scanning speed, since no transversal positioning is required during a single pass.

As it will appear clear from the foregoing discussion the object of the invention is fulfilled according to other aspects of the present invention by an apparatus for recording data on a recording medium as claimed in claim 10, by a recording medium as claimed in claim 11, and by a method and an apparatus for reading data from the recording medium as claimed in claims 12 and 13 respectively.

Although the invention is especially envisaged for being applied to pre-recorded recording media, the invention can equally be applied to recording media recordable by the user, both of one time recordable type or rewritable, or hybrid media.

When applied to a BD, the advantages of using this method include the fact that the required recorded mark length accuracy is substantially less than with known methods, the decoding part of the unique identifier can be built completely in firmware; no hardware change required in the decoder IC or elsewhere, and an existing decoder can be re-used to detect and decode the unique identifier encoded in the modulating data marks.

These and other aspects of the invention will be further elucidated and described with reference to the drawings. In the drawings:

FIGS. 1A and 1B illustrate previously-considered post-recording techniques,

FIG. 2 illustrates a principle of the present invention,

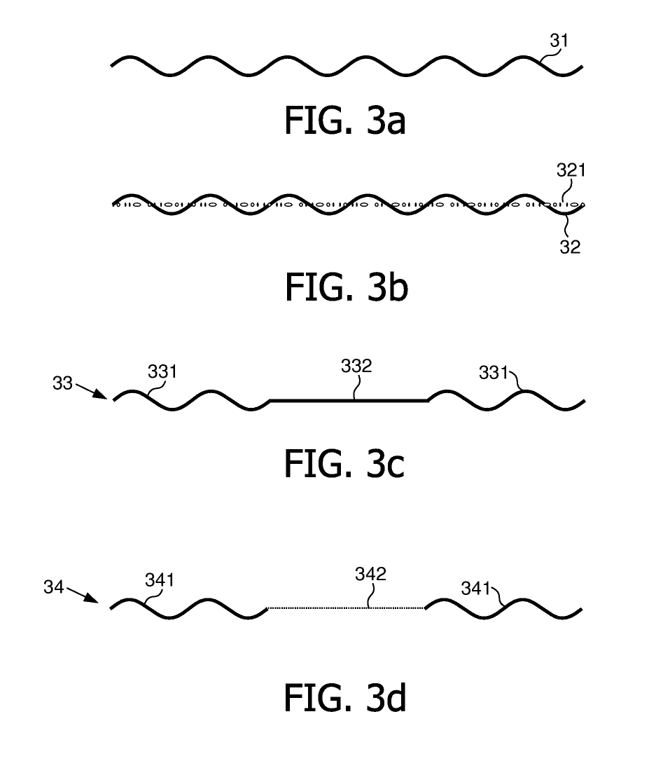

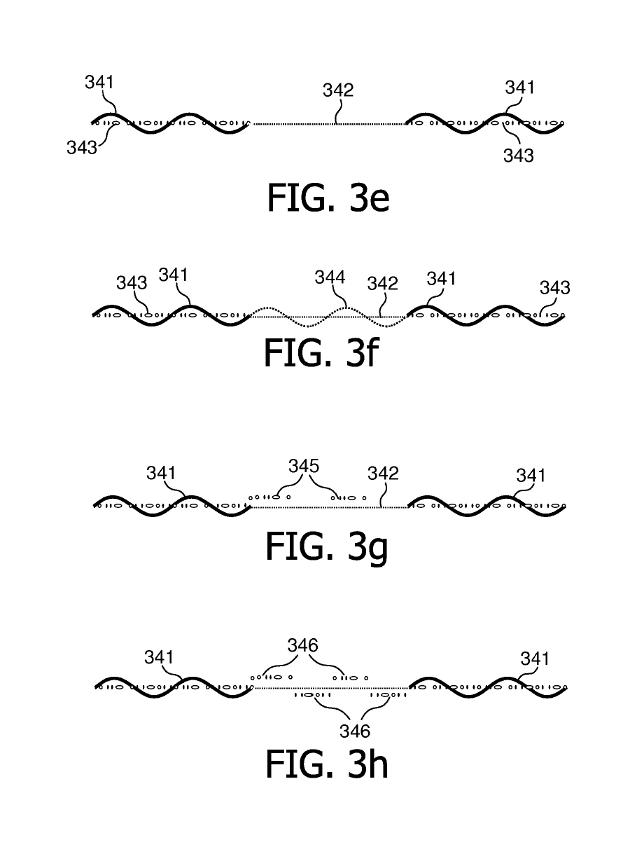

FIG. 3 illustrates results of steps in a method embodying the present invention,

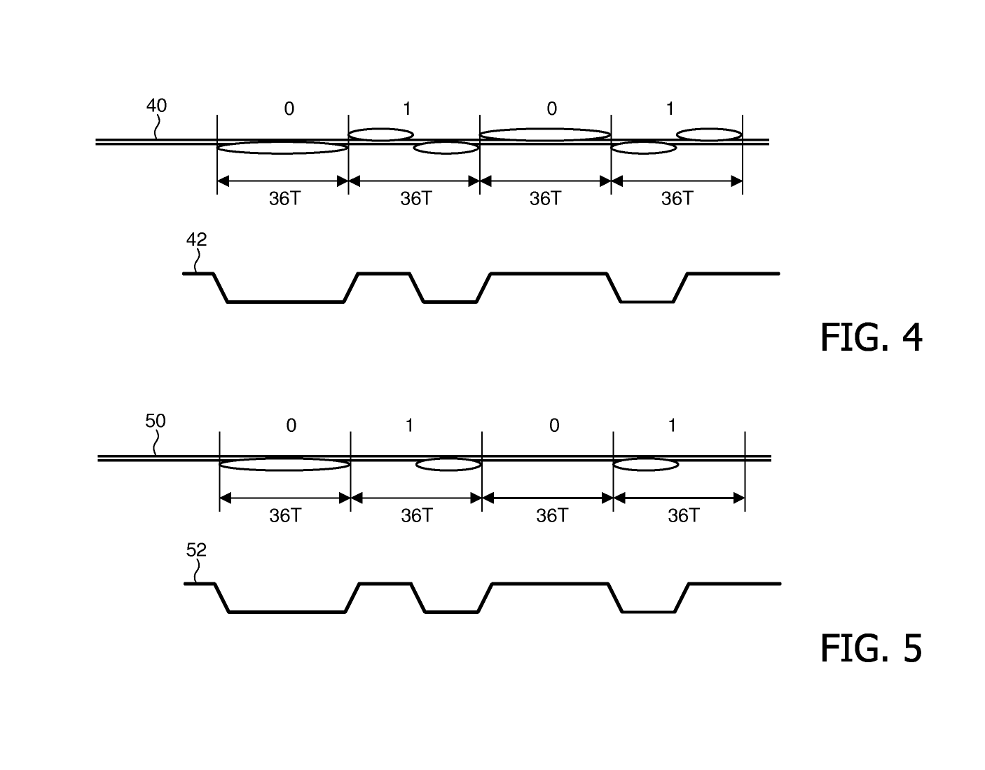

FIG. 4 illustrates results of a method embodying the present invention,

FIG. 5 illustrates results of another method embodying the present invention,

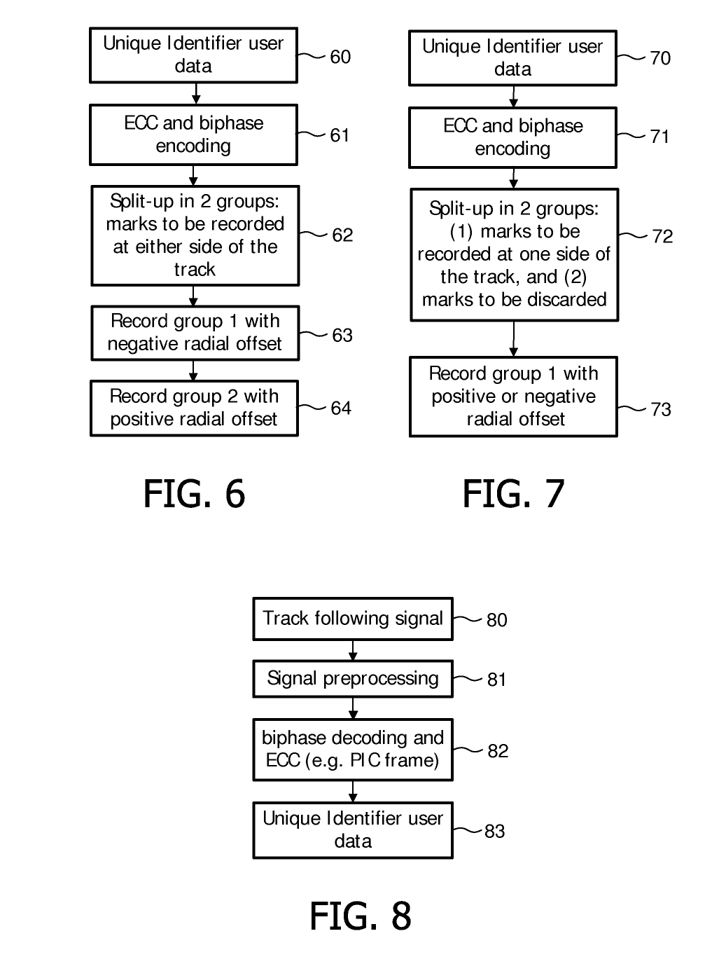

FIGS. 6 and 7 illustrate steps in methods embodying the present invention, and

FIG. 8 illustrates a method for decoding date recorded using a method embodying the present invention.

FIG. 2 illustrates the principle of the present invention. As described above, optical discs can be provided with a modulated data track. That is the data track 20 is such that it defines periodic variations in radial position, relative to the average track position 21. In the example shown in FIG. 2, the data track 20 is sinusoidal in shape.

In an embodiment of the present invention, data marks are recorded on the optical disc so as to replicate the periodic variations in radial position of the data track 20, along a control data portion of the data track. In one example, the control data portion of the data track is substantially free from such periodic variations. In another example, the control data portion may be modulated in a different manner to the remainder of the data track. In yet another example, the control data portion may be provided by a groove which has physical characteristics (width, depth, etc.) different from the remainder of the data track.

In FIG. 2, the data marks are illustrated by marks 22 and 24. The data marks can encode any appropriate information onto the disc. For example, the data marks may encode a unique serial number for the optical disc, a serial number that is required for audio/video output from the disc, or a serial number for an application stored on a computer.

FIG. 3 illustrates data tracks at various stages of processing. Data track 31 shows the modulated groove without recorded marks. The groove modulation is a high frequency periodic variation; in this case a sinusoidal variation. Track 32 is the conventionally recorded track; the recorded marks 321 are positioned in the average track center.

Data track 33 is provided for enabling the write technique according to the present invention. The track 33 includes a modulation portion 331 in which the track varies in radial position. In FIG. 3, the variations in radial position are all shown as sinusoidal variations for the sake of simplicity. Other periodic variations that result in a desired average track position are possible. The data track 33 is also provided with a control data portion 332 as a reserved area which, in this example, is substantially free from such variations in radial position and which is the control data portion for the marks recorded with the write technique according to the present invention.

Data track 34 illustrates an alternative to data track 33, in which a portion of the track is provided with periodic variations, as before, 341, and the control data portion 342 is provided by a lack of defined track. Data marks 343 are written to the track 34 along the average position of the modulated portion of the track, as before. The control data portion 342 remains free from such recording marks. As shown in FIG. 3F, an intended track variation pattern 344 is illustrated. This pattern 344 is to be simulated/provided by the writing of data marks. FIG. 3G illustrates data marks 345 being written to one side of the control data portion of the data track 34, and FIG. 3H illustrates data marks being recorded to both sides of the control data portion of the data track 34. In this way, the radial variations in data track can be simulated by the writing of specific data marks in radially offset positions with regard to the control data portion 342 of the data track 34.

In FIG. 4 it is shown how the marks of the unique identifier can be recorded. Marks can be recorded with a radial offset on both sides of the control data portion of the data track. The recording of the marks is performed in two rotations in one example, since the optical recording head cannot make radial displacements at high velocity. Alternatively, the linear velocity during recording may be chosen such that the optical head is able to follow the radial displacement that is necessary to record the marks.

The marks may also be recorded to one side of the groove only. The track following signal will be modulated according to if a recorded mark is present or not, as illustrated in FIG. 5.

FIG. 6 is a flow chart illustrating steps in a method embodying the present invention in which unique identified data is written according to the present invention to both sides of a nominal radial position of a track. In step 60, the unique identifier user data is generated or received, and is then (optionally) protected by an error correction coding (ECC) or error detection coding (EDC), and then encoded in a biphase coding (step 61). The use of ECC or EDC is optional, and the use of biphase encoding is exemplary and can be replaced by any suitable form of encoding. The encoded data is then split into two groups, one group to be recorded to one side of the data track, the other group to be recorded to the other side of the data track (step 62). In step 63, the first group of data marks are recorded to one side of the control data portion of the data track, and at step 64 the second group of marks are recorded to the other side of the control data portion of the recorded track. In the example shown in FIG. 6, the first group are recorded at a negative offset from the control data portion of the data track, and the second group are recorded with a positive offset from the control data portion of the data track. The result of this process is that data marks are recorded to each side of the average portions of the data track, at predetermined radial offsets from that data track, such as to simulate the radial variation along the remainder of the track in the modulated portion.

FIG. 7 illustrates a method embodying the present invention for recording unique identifier data to a single side of the control data portion of the data track. Unique identifying user data is obtained in step 70, and submitted to ECC and biphasing encoding in step 71. The encoded data is split into two groups, the first group relates to data marks to be recorded to one side of the track, and the second group relates to data to be discarded. The grouping of data is arbitrary, and merely requires that the data to be written cause a modulation in the radial error signal relating to the data track. In step 73, the marks to be recorded are recorded on the optical disc at a predetermined radial offset from the control data portion of the track.

FIG. 8 illustrates decoding of the unique identified information recorded on an optical disc using a method embodying the present invention. At step 80, the usual track following signal is used to detect the unique identified data written at a radially offset position from the nominal track position, and at step 81 this resulting signal is pre-processed, in preparation for decoding and (optional) error detection/correction (step 82). The result of this decoding step is the unique identifier user data recorded along the control data portion of the data track (step 83).

The detection of the unique identifier is performed using the track following signal. This signal is fed to the decoder, for example, the PIC-decoder of the Blu-ray disc system.

Embodiments of the present invention can thereby provide a method to record marks on an optical disc in such a way that the pattern of recorded marks gives a modulation in the tracking channel in an identical way as groove wobble or pit wobble. This means that existing detection means can be used, as generally is already available to read out groove/pit wobble (such as HFM groove detection). No or minimal hardware changes are therefore needed.

The method can be used to mimic pit-wobble or groove-wobble of the type that is used, for example, in discs with digital rights management.

The method can be used to record a unique identifier on a BD-ROM disc.

The invention can be summarized as follows. An individual code can be recorded on optical discs with post-recording techniques like for example laser-ablation. This normally requires the presence of an ad-hoc decoder in a corresponding playback apparatus. According to the invention this individual code is recorded by using an encoding scheme which is different from the encoding scheme proper of the user data but equal to the encoding scheme proper of control data already foreseen in the disc, like for example PIC in the case of a BD. In this way an ad-hoc decoder is no longer required and a suitable playback apparatus capable of acquiring individual code can be obtained with minimal modifications of an existing playback apparatus.

1. A method of recording data on a recording medium having a data track defining a primary control data portion and a user data portion, the user data portion being for storing user data and having and a reserved area, the primary control data portion having primary control data written there along according to a primary control data encoding scheme, according to which primary control data encoding scheme the primary control data are encoded into a transversal displacement of a groove from the center of the data track, the method comprising writing data marks in the reserved area of the data track to form a path which varies in transversal position with respect to the center of the data track, such that the path encodes secondary control information in accordance with the primary control data encoding scheme.

2. A method as claimed in claim 1, wherein the secondary control information comprises an identification code of the recording medium.

3. A method as claimed in claim 1, wherein in the data portion the data track has periodic variations in transversal direction.

4. A method as claimed in claim 3, wherein in the reserved area the data track has variations in transversal direction which are different from the periodic variations in the rest of the data portion.

5. A method as claimed in claim 1, wherein in the reserved area the data track is substantially free of variations in transversal direction.

6. A method as claimed in claim 1, wherein the data marks are written to the disc in a single recording pass.

7. A method as claimed in claim 1, wherein the data marks are written to the disc in at least two recording passes.

8. A method as claimed in claim 7, wherein the data marks are written at fixed transversal displacement in each pass of the at least two recording passes.

9. A method as claimed in claim 1, wherein the recording medium is an optical disc.

10. An apparatus for recording data on a recording medium having a data track defining a primary control data portion and a user data portion, the user data portion being for storing user data and having a reserved area, the primary control data portion having primary control data written there along according to a primary control data encoding scheme, according to which primary control data encoding scheme the primary control data are encoded into a transversal displacement of a groove from the center of the data track, the apparatus comprising a writing unit for writing data marks in the reserved area of the data track to form a path which varies in transversal position with respect to the center of the data track, such that the path encodes secondary control information in accordance with the primary control data encoding scheme.

11. A recording medium having a data track defining a primary control data portion and a user data portion, the user data portion being for storing user data and having a reserved area, the primary control data portion having primary control data written there along according to a primary control data encoding scheme, according to which primary control data encoding scheme the primary control data are encoded into a transversal displacement of a groove from the center of the data track, the recording medium further comprising data marks written in the reserved area of the data track and forming a path which varies in transversal position with respect to the center of the data track, such that the path encodes secondary control information in accordance with the primary control data encoding scheme.

12. A method of reading data from a recording medium having a data track defining a primary control data portion and a user data portion, the user data portion being for storing user data and having a reserved area, the primary control data portion having primary control data written there along according to a primary control data encoding scheme, according to which primary control data encoding scheme the primary control data are encoded into a transversal displacement of a groove from the center of the data track, the recording medium further comprising data marks written in the reserved area of the data track and forming a path which varies in transversal position with respect to the center of the data track, such that the path encodes secondary control information in accordance with the primary control data encoding scheme, in which method a control data decoding unit is used for acquiring the primary control data from the primary control data portion, the method further comprising using the control data decoding unit also to acquire the secondary control information from the reserved area.

13. An apparatus for reading data from a recording medium having a data track defining a primary control data portion and a user data portion, the user data portion being for storing user data and having a reserved area, the primary control data portion having primary control data written there along according to a primary control data encoding scheme, according to which primary control data encoding scheme the primary control data are encoded into a transversal displacement of a groove from the center of the data track, the recording medium further comprising data marks written in the reserved area of the data track and forming a path which varies in transversal position with respect to the center of the data track, such that the path encodes secondary control information in accordance with the primary control data encoding scheme, in which apparatus a control data decoding unit is present for acquiring the primary control data from the primary control data portion, the control data reading unit being adapted for acquiring also the secondary control information from the reserved area.
